(19) United States
(12) Patent Application Publication
(10) Pub. No.: US 2023/0133474 A1
(43) Pub. Date: May 4, 2023

(54) METHOD AND PACKAGING MACHINE FOR MANUFACTURING A COMPOSTABLE POD FOR BREWING PRODUCTS

(71) Applicant: SOCIETE DES PRODUITS NESTLE S.A., Vevey (CH)

(72) Inventors: FRANCO MAGNANI, Chicago, IL (US); MASSIMILIANO MAINI, Fidenza (Parma) (IT)

(21) Appl. No.: 17/760,455

(22) PCT Filed: Jan. 28, 2021
(86) PCT No.: PCT/IB2021/050654

§ 371 Date: Aug. 10, 2022

(30) Foreign Application Priority Data
Feb. 10, 2020 (IT) 102020000002533

(51) Int. Cl. B65B 29/02; B65B 9/04; B31F 1/00

(52) U.S. Cl. CPC B65B 29/025; B65B 9/042; B31F 1/0077

(57) ABSTRACT

A method for manufacturing a compostable pod for brewing products involves arranging a first (2) and a second sheet (3) made of biodegradable material with gas barrier properties; shaping the sheets (2, 3) so as to make at least one first concave portion (2a) on the first sheet (2) and at least one second concave portion (3a) on the second sheet (3) delimited by respective peripheral annular portions (2a′, 3a′), folding the sheets (2, 3) at the peripheral annular portions (2a′, 3a′) so as to define respective stiffening annular portions (2b, 3b) of the sheets (2, 3), filling the first concave portion (2a) with a predetermined quantity (4) of a brewing product, and coupling the sheets (2, 3) at the peripheral annular portions (2a, 3a) so that the respective concavities of the concave portions (2a, 3a) are opposite each other and define a housing volume of said brewing product.

This invention relates to a method and a packaging machine for manufacturing a compostable pod for brewing products.

This invention finds its main application in the food sector, more particularly in the technical field of manufacturing pods for brewing products, such as coffee or tea, or the like.

In the last few years, in the field of brewing products, packaging solutions for products such as capsules and pods have become increasingly popular. These solutions ensure the brewing products are easy to use in special machines that speed up the preparation of the drink.

Although, of the two main solutions, the pod was considered preferable due to its only having biodegradable material (e.g., filter paper) in contact with the product, over time the technique increasingly focused on improving the quality of capsules, both for reasons of economy and in the light of capsules' better maintenance of the organoleptic qualities of the product.

In fact, capsules make it possible to avoid the need for additional packaging with respect to the capsule itself and, by their very nature, guarantee a gas barrier that maintains the quality of the product contained therein, even for long periods.

For this reason, some manufacturers have recently opted to modify the concept of the “pod”, developing models that, while maintaining the canonical disc conformation, were made with materials capable of providing a gas barrier, such as aluminium, or the like.

Unfortunately, this solution is not in line with the significant increase in recent years in both institutions' and consumers' awareness regarding environmental issues.

The use of materials other than aluminium, today, encounters, moreover, considerable problems of both stability and size, thus discouraging technicians in the sector from experimenting with the use of biodegradable/compostable materials.

During the shaping step for shaping the concave portions defining the two halves of the pod, it is, in fact, possible that the sheets of compostable material undergo sagging, displacements, and misalignments due to the poor stiffness of the material, which can result in the pod's ineffective closure during the coupling of the sheets.

In addition, the Applicant has pointed out that the use of biodegradable material may lead to shrinkage in the material itself, which may result in tears or cracks in the finished pod.

The purpose of this invention is, thus, to overcome the drawbacks of the prior art mentioned above.

In particular, the purpose of this invention is to provide a method and a packaging machine for manufacturing a pod for brewing products that enables the use of compostable materials, increasing the efficiency of the production process and improving the quality of the pod that is made.

Said purpose is achieved with a method for manufacturing a compostable pod for brewing products with the characteristics of one or more of claims 1 to 5, and with a packaging machine for manufacturing a compostable pod for brewing products with the characteristics contained in claim 12.

In particular, the method involves arranging a first and second sheet made of biodegradable material with gas barrier properties.

The method preferably involves forming the sheets so that at least one first concave portion is made on the first sheet and at least one second concave portion is made on the second sheet, wherein the concave portions are bounded by respective peripheral annular portions.

According to a first aspect of this invention, the method comprises the step of folding the sheets at the peripheral annular portions so as to define respective stiffening annular portions in the sheets.

The method preferably involves the step of filling the first concave portion with a predetermined quantity of a brewing product.

The method preferably involves the step of coupling the sheets at the peripheral annular portions so that the respective concavities of the concave portions are opposite each other and define a housing volume of said brewing product.

The stiffening annular portions, therefore, advantageously enable the concave portions to be stiffened externally so that the subsequent coupling steps are carried out correctly and precisely.

In this way, the efficiency of the packaging process is improved, as no machine stoppages or special devices for supporting, checking, and aligning the sheets are required, and the resulting pod is qualitatively improved.

The shaping step and the folding step are preferably carried out simultaneously in order to optimise the packaging process.

The method preferably comprises a cutting step for cutting the peripheral annular portions following the coupling step, along respective cutting lines between the concave portions and the stiffening annular portions.

Advantageously, the presence of stiffening annular portions increases the stiffness of the sheets and keeps them in the correct position during the cutting step.

The shaping steps for the first and second sheets preferably involve moistening at least a first portion of said first sheet and a second portion of said second sheet.

In addition, it preferably involves configuring said first and said second portion so as to make said first and said second concave portion.

There is, preferably, a drying step for drying the first and second concave portion.

Advantageously, thanks to the moistening step, it is possible to make the cellulose components of the biodegradable material with gas barrier properties more malleable, making it possible to conform the moistened portions by punching or other methods known in and of themselves.

In addition, the subsequent drying step enables the moistened and conformed material to crystallize, thus maintaining the correct profile to proceed with the filling and final closure of the pod.

This methodology therefore makes it possible to manufacture a compostable pod with gas barrier properties in a simple and cost-effective way that is advantageous for the manufacturer.

This invention also relates to a shaping station and a packaging machine for manufacturing a compostable pod for brewing products, comprising said shaping station.

The shaping station comprises a feeding unit of at least one sheet made of biodegradable material with gas barrier properties and a conformation device.

The conformation device shall preferably comprise a shaping device and a folding device.

The shaping device comprising at least one movable punch moving closer to and away from a die provided with a concavity delimited around the edge by a peripheral edge.

The shaping device is configured to form at least one concave portion and one corresponding peripheral annular portion on the respective sheet.

The folding element is configured to be placed outside the peripheral edge of the die to make a fold in the sheet at the peripheral annular portion so as to define at least one stiffening annular portion on the sheet.

Advantageously, therefore, the presence of the folding element makes it possible to stiffen the sheets at the peripheral annular portions adjacent to the concave portions that will be used to make the pod once coupled.

The folding element is preferably mobile, moving closer to and away from an abutment portion that is placed outside the peripheral edge of the die and configured to receive the folding element against it in order to make the fold.

The abutment portion, with reference to a reciprocal movement direction between the punch and the die, is preferably interposed between the peripheral edge of the die and a bottom portion of the concavity.

Advantageously, this configuration enables the creation of the stiffening annular portion on the sheet

The distance, measured along the reciprocal movement direction between the punch and the die, between the peripheral edge and the abutment portion preferably ranges between 0.5 mm and 2 mm, and is, even more preferably, 1.3 mm.

The distance, measured along the reciprocal movement direction between the punch and the die, between the peripheral edge and the bottom portion, preferably ranges between 3 mm and 7 mm, and is, even more preferably, 5 mm.

There is also, preferably, at least one moistening device of at least one portion of said first or second sheet.

In addition, heating elements are preferably provided, configured to dry said portion enabling the maintenance of said concave conformation.

Advantageously, the packaging machine is provided with a first shaping station configured to provide a first sheet made of biodegradable material with gas barrier properties provided with at least one first concave portion and a second shaping station configured to provide a second sheet made of biodegradable material with gas barrier properties provided with at least one second concave portion.

In addition, there is a filling station operationally arranged downstream of said first shaping station and configured to fill said first concave portion with a predetermined quantity of a brewing product.

Finally, a coupling station is operationally arranged downstream of said filling station and is configured to couple the sheets at the peripheral annular portions so that the respective concavities are opposite each other and define a housing volume of said brewing product.

In accordance with a second aspect of this invention, which is alternative or complementary to the preceding one, there is a method and a machine for making a compostable pod for brewing products characterised in that the depth of the concavity of the die of the shaping device is oversized in relation to half the height of the packaged pod.

In other words, by coupling deeper concave portions, for the same quantity of brewing product inserted, even if shrinkage in the compostable material with gas barrier properties should occur (which may result in compacting of the pod and therefore thinning of the pod thickness) the shrinkage would be compensated for.

These and other features, together with the advantages related thereto, will become more apparent from the following illustrative, therefore non-limiting, description of a preferred, thus non-exclusive, embodiment of a machine and method for manufacturing a compostable pod for brewing products according to what is illustrated in the attached figures, wherein:

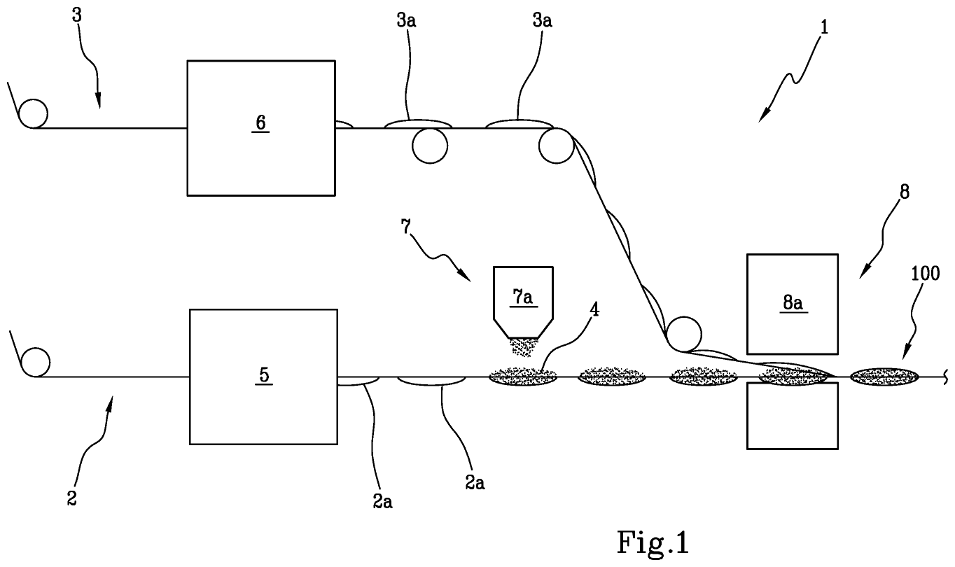

FIG. 1 shows a schematic elevation view of a packaging machine for manufacturing a compostable pod for brewing products according to this invention;

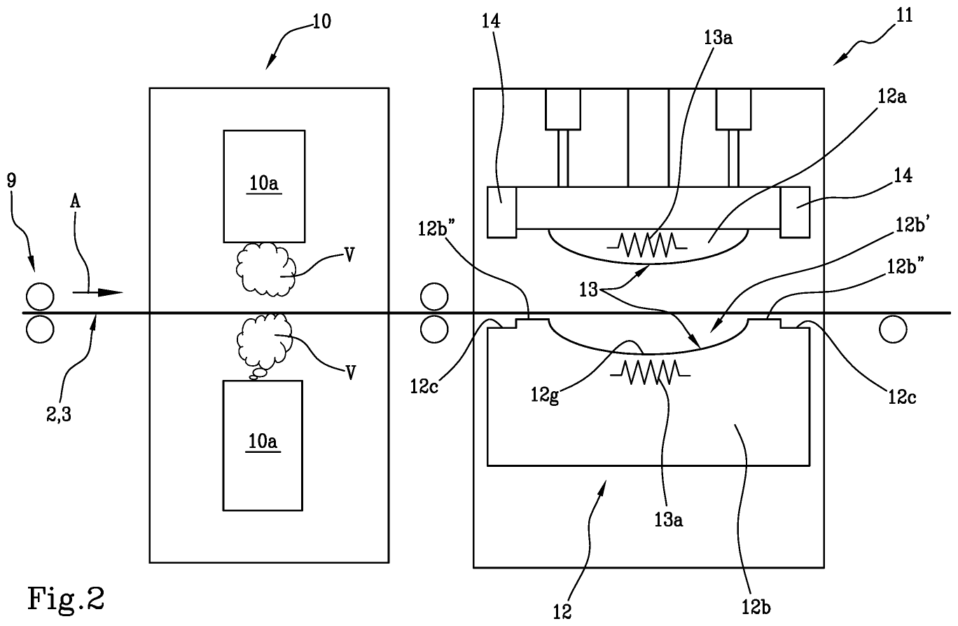

FIG. 2 shows a schematic view in elevation of a shaping station for the packaging machine in FIG. 1;

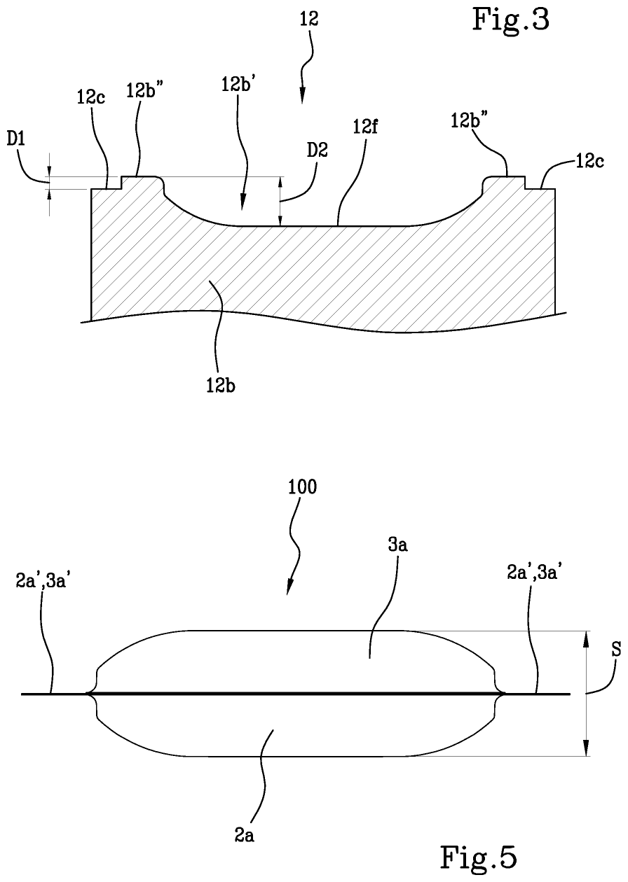

FIG. 3 is an enlarged schematic view of the die of the shaping device illustrated in FIG. 1;

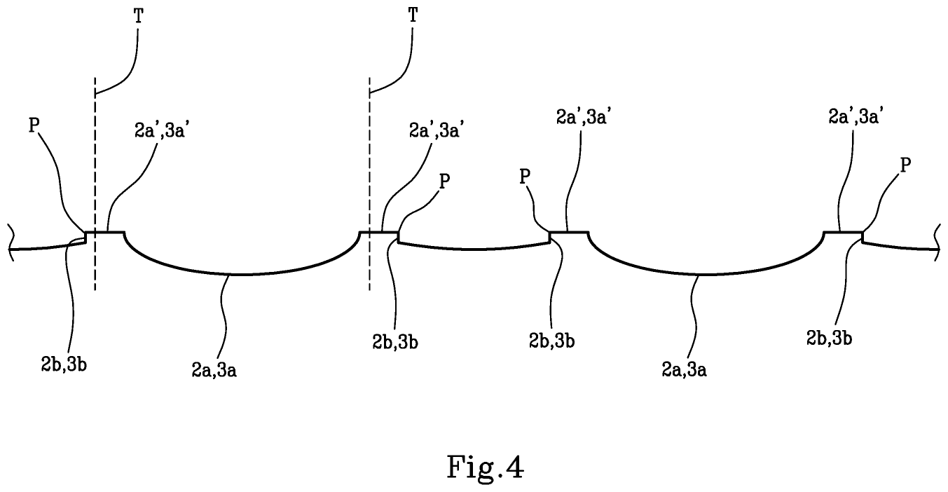

FIG. 4 is a schematic cross-section of a sheet shaped with the packaging machine that is the subject of this invention, and

FIG. 5 shows a side view of a pod 100 made using the packaging machine in FIG. 1.

With reference to the appended figures, the reference number 1 denotes a packaging machine used to implement the method for manufacturing a compostable pod for brewing products according to this invention.

The machine 1, as well as the manufacturing method implemented by it, therefore finds application in the production and manufacture of disposable compostable pods, of the type used in preparing beverages, mostly hot, by brewing or percolation.

Generally speaking, the pod 100 is an element comprising a first concave portion 2a and a second concave portion 3a coupled to each other so that their respective concavities are opposite each other and define a housing volume within which a predetermined quantity of a brewing product is placed.

It should be noted that the pods 100 manufactured with the machine and method according to this invention may be of various types and the brewing products contained therein may be the most varied, such as (preferably) coffee, tea, herbal tea, or the like.

Procedurally, a first 2 and a second sheet 3 are first prepared from biodegradable material with gas barrier properties.

The term “sheet” is intended to define any flexible element with a planar extension having two flat faces opposite each other.

It should be noted that the definition of “sheet” is intended to include both elements with a well-defined planar extension and reels of material in which the length of the material is much greater than its width.

In fact, the spirit of the invention is intended to include both “in-line” solutions and more stationary solutions, in which single sheets of material are processed in a separate manner.

The first 2 or second sheet 3 made of biodegradable material with gas barrier properties is a preferably made of a composite having a cellulosic component and a biopolymeric or bioplastic component.

This material is devoid of any fossil or petroleum derivative content, allowing it to be considered fully compostable or biodegradable under any national regulations, even the most stringent.

In a preferred embodiment, the biodegradable material with gas barrier properties has a weight ranging between 90 and 150 grams.

The biodegradable material with gas barrier properties preferably comprises multiple overlapping layers, including one or more of the following:
a non-woven fabric that is at least 40% by weight, preferably 100%, made of biodegradable fibres;
a layer of adhesive suitable for contact with food, in any case less than 5% by weight of the material;
a barrier medium that reduces gas permeability, such as vegetable parchment or the like.

The biodegradable fibres used may for example be selected from a group containing:
PLA (polylactic acid),
PHA (polyhydroxyalkanoates);
PHB (polyhydroxybutyrate);
PHB(V) (polyhydroxybutyrate-co-hydroxyvalerate);
PBS (polybutylene succinate);
biopolyester;
cellulose fibres such as cotton, flax, and wood fibres.

The adhesive layer, if present, is preferably of the acrylic type.

In order to manufacture the pod 100, it is generally necessary to include a step for shaping the first 2 and second sheet 3 so that the first concave portion 2a is made on the first sheet 2 and the second concave portion 3a is made on the second sheet 3.

An array of first concave portions 2a and a corresponding array of second concave portions 3a are, preferably, made on the first 2 and second sheet 3.

In particular, the shaping of the sheets 2, 3 creates concave portions 2a, 3a bounded by corresponding peripheral annular portions 2a′, 3a′.

It should be noted that, such shaping steps may be performed at the same time or in successive steps, at the same station or at different stations, in each case adhering to the spirit of this invention.

Advantageously, the method then comprises a folding step for folding the sheets 2, 3 at the peripheral annular portions 2a′, 3a′ so as to define respective stiffening annular portions 2b, 3b of the sheets 2, 3, as illustrated in FIG. 4.

In accordance with a possible embodiment of this invention, the shaping steps of the first 2 and second sheet 3 preferably involve moistening at least one first portion of said first sheet 2 and a second portion of said second sheet 3.

Moistening or soaking the sheet portions 2, 3 is preferably performed by hitting the first and said second portions with at least one steam jet at a predetermined temperature.

Alternatively, however, the moistening step could be performed using other methods. For example, the moistening step could be performed by nebulisation of a liquid (e.g., demineralised water) on the sheet 2, 3 or by soaking the sheet 2, 3 by means of suitable devices (baths, rollers, sponges).

In accordance with a preferred embodiment, the step of moistening the first or second portion is performed by hitting the two faces of each first 2 or second sheet 3 with two separate, preferably independently driven and adjustable, steam jets.

Advantageously, this enables differentiated soaking of the different layers of the biodegradable material with gas barrier properties.

The shaping step also involves conforming the first and second portion so as to make the first 2a and second concave portion 3a.

In other words, it involves conforming, for example by means of a punch, mould, or the like, the previously moistened portion of the first 2 and the second sheet 3.

In this way, the cellulose fractions of the material are, advantageously, more malleable and the risk of breakage is considerably reduced, while maintaining production speeds compatible with the cycle times required by today's market.

Following the conformation, or concurrently therewith, the first 2a and second 3a concave portions are then dried.

In other words, the drying step involves heating the first 2a and the second 3a concave portions, concurrently with or subsequent to said conformation, so as to crystallize the shape of the resulting material.

The concave portions 2a, 3a resulting from the shaping step are then used to manufacture the pod 100.

In particular, the first concave portion 2a is filled with a predetermined quantity 4 of a brewing product, which, as already mentioned, can be of various kinds.

The method then involves coupling the sheets 2, 3 at the peripheral annular portions 2a′, 3a′ so that the respective concavities of the concave portions 2a, 3a are opposite each other and define a housing volume of the brewing product.

In other words, the first concave portion 2a filled with said quantity 4 is coupled with the second concave portion 3a so that the respective concavities are opposite and define a housing volume for said brewing product.

Advantageously, therefore, the method to which this invention relates makes it possible to manufacture a pod 100, wherein both the first 2a and the second concave portion 3a are pre-shaped and made of a biodegradable material with gas barrier properties of a high quality. In fact, coupling the peripheral annular portions 2a′, 3a′ is precise and effective since the sheets 2, 3 have been stiffened by the stiffening annular portions 2b, 3b during the folding step.

The shaping step and said folding step are preferably carried out simultaneously, as will be clearer in the following description.

Finally, the method preferably comprises a cutting step for cutting the peripheral annular portions 2a′, 3a′, following the coupling step, along respective cutting lines T (as illustrated in FIG. 4) between the concave portions 2a, 3a and the stiffening annular portions 2b, 3b.

Thus, the stiffening annular portions 2b, 3b constitute waste at the end of the process, but play an important supporting and stiffening function during the coupling steps.

In order to implement this method, for example, the packaging machine 1 to which this invention relates is used.

This machine 1 comprises one or more shaping stations 5, 6, a filling station 7, and a coupling station 8.

In particular, the machine 1 comprises a first shaping station 5 and a second shaping station 6.

The first shaping station 5 is configured to provide the first sheet 2 of biodegradable material provided with said first concave portion 2a, preferably with an array of first concave portions 2a.

The second shaping station 6 is configured to provide the second sheet 3 made of biodegradable material provided with said second concave portion 3a, preferably with an array of second concave portions 3a.

It should be noted that the first 5 and the second shaping station 6 could be located within the same device and act simultaneously on the two sheets 2, 3 or be physically separated from each other, adhering, in any case, to the spirit of this invention.

Each shaping station 5, 6 comprises a feeding unit 9 of the corresponding first 2 or second sheet 3 of biodegradable material with gas barrier properties.

This feeding unit 9 is configured to feed the sheet 2, 3 (or ribbon) along a forward direction “A”.

Along said forward direction “A”, there is preferably a moistening device 10 of at least one portion of the respective first 2 or second 3 sheet.

The moistening device 10 preferably comprises at least one steam generator 10a configured to generate a steam jet “V” hitting the comprises portion of the first 2 or second 3 sheet.

In the preferred embodiment, the moistening device 10 comprises two steam generators 10a opposite each other, each oriented towards a corresponding face of the first 2 or second 3 sheet.

These steam generators 10a are preferably independently driven, in order to differentiate and optimise the soaking of each face of the sheet 2, 3.

Alternatively, however, other moistening systems could be used, such as nebulising nozzles/sprays or application rollers (e.g., with brushes or sponges).

The shaping station 5, 6 comprises a conformation device 11, preferably operationally arranged downstream of the moistening device 10.

The conformation device 11 comprises at least one shaping device 12.

The shaping device 12 is configured to give the, preferably soaked, portion of the sheet a concave conformation.

With reference to FIG. 2, the shaping device 12 comprises at least one punch 12a, preferably convex, that can be moved closer to and away from a die 12b—which is preferably concave, provided with a concavity 12b′, and delimited around the edge by a peripheral edge 12b″—in a reciprocal movement direction (preferably perpendicular to the forward direction A).

Thus, the shaping device 12 is configured to form at least one concave portion 2a, 3a and one corresponding peripheral annular portion 2a′, 3a′ on the respective sheet 2, 3.

Advantageously, the conformation device 11 comprises a folding element 14 configured to be placed outside the peripheral edge 12b″ of the matrix 12b to make a fold P in the sheet 2, 3 at the peripheral annular portion 2a′, 3a′ so as to define at least one stiffening annular portion 2b, 3b of the sheet 2, 3.

In other words, the folding element 14 pushes the sheet 2, 3 and folds it along the peripheral edge 12b″ creating the fold P that results in a stiffening of the area itself. In fact, the presence of a stiffening annular portion 2b, 3b, which is not coplanar, and preferably lying substantially on a transverse plane in relation to the peripheral annular portion 2a′, 3a′, increases the stiffness of the sheet 2, 3.

In other words, as a result of the intervention of the folding element the peripheral annular portions 2a′, 3a′ are arranged to straddle the respective peripheral edge 12b″, with the fold P and the annular edge of the concave portion 2a, 3a grasping the corresponding edges (or fittings) of the peripheral edge 12b″. In this way, the correct positioning of the concave portion within the concavity is ensured, improving product quality and reducing waste.

The folding element 14 is preferably mounted on the shaping device 12 and can preferably be moved in conjunction with this device.

The folding element 14 can preferably be moved closer to and away from an abutment portion 12c that is placed outside the peripheral edge 12b″ of the die 12b and configured to receive said folding element 14 against it in order to make the fold P.

With particular reference to FIG. 3, the abutment portion 12c, with reference to the reciprocal movement direction between the punch 12a and the die 12b, is preferably interposed between the peripheral edge 12b″ of the die 12b and a bottom portion 12f of the concavity 12b′.

The distance D1, measured along the reciprocal movement direction, between the peripheral edge 12b″ and the abutment portion, preferably ranges between 0.5 mm and 2 mm, and is, even more preferably, 1.3 mm.

The distance D2, measured along the reciprocal movement direction, between the peripheral edge 12b″ and the bottom portion 12f, ranges between 3 mm and 7 mm, and is, even more preferably, 5 mm.

In this regard, according to an additional aspect of this invention, in order to solve the problem of shrinkage in the biodegradable material with gas barrier properties with which the sheet 2, 3 is made, it is possible to determine the distance D2 so that it is half the thickness S of the packaged pod 100 increased by an additional value X able to compensate for this material shrinkage, whereby D2=S/2+X.

The additional value X may preferably take a value ranging between 10% and 30% of the thickness S.

Therefore, by increasing the depth of the concavity 12b′ of the die 12b, for the same amount of brewing material inserted into the first concave portion 2a, it is possible to prevent shrinkage in the biodegradable material with gas barrier properties from resulting in the breaking of the pod 100.

The conformation device then, preferably, comprises heating means 13 configured to dry the conformed sheet portion 2, 3, allowing subsequent maintenance of said concave conformation.

In addition, the heating means 13 preferably comprise a heating device 13a joined to said punch 12a and/or to said die 12b in order to dry the concave portion 2a, 3a of the first 2 or second 3 sheet during its conformation.

The heating device 13a is preferably defined by at least one resistor integrated into the punch 12a or die 12b.

In the preferred embodiment, the shaping device 12 is configured to exert a compressive force ranging from 1000 to 3000 N.

On the other hand, the heating device 13a is preferably configured to raise the temperature of the punch 12a or die 12b to a temperature ranging between 50 and 130° C. during the conformation step. Advantageously, a precise conformation of the concave portions 2a, 3a can thus be obtained quickly and reliably.

The filling station 7 preferably comprises a dosing device 7a, itself known and therefore not described in detail. The dosing device 7a may be of the weight, time, or volume type, in each case adhering to the spirit of this invention.

The coupling station 8, in turn, may be of various types. It preferably involves using an ultrasonic welding device 8a (sonotrode) in order to avoid or limit the presence of adhesive.

Alternatively, however, a heat sealer or other known system may be used.

The drying step carried out during the conformation also allows a precise maintenance of the conformation, facilitating the subsequent filling and coupling steps and freeing the producer from the need to use suction or vacuum systems to maintain it.

This invention achieves the proposed purposes, overcoming the drawbacks complained of in the prior art and providing the user with a method and a machine for manufacturing a compostable pod made of biodegradable material with gas barrier properties for high-quality brewing products.

In particular, the invention makes it possible to effectively implement the coupling step for coupling the two concave portions that make the capsule.

1. A method for manufacturing a compostable pod for brewing products, comprising the following steps:
arranging a first and a second sheet made of biodegradable material with gas barrier properties;
shaping said sheets so as to make at least one first concave portion on said first sheet and at least one second concave portion on said second sheet delimited by respective peripheral annular portions;
folding said sheets at said peripheral annular portions so as to define respective stiffening annular portions of the sheets;
filling the first concave portion with a predetermined quantity of a brewing product; and
coupling the sheets at the peripheral annular portions so that the respective concavities of the concave portions are opposite each other and define a housing volume of said brewing product.

2. The method according to claim 1, wherein said shaping step and said folding step are carried out simultaneously.

3. The method according to claim 1, comprising a cutting step for cutting the peripheral annular portions, following the coupling step, along respective cutting lines between the concave portions and the stiffening annular portions.

4. The method according to claim 1, wherein said first or second sheet made of biodegradable material with gas barrier properties is a composite having a cellulose component and a biopolymer or bioplastic component.

5. The method according to claim 1, wherein said shaping steps for the first and second sheet involve:
moistening at least one first portion of said first sheet and a second portion of said second sheet;
conforming said first and said second portion so as to make said first and said second concave portion; and
drying said first and said second concave portion.

6. A shaping station for a compostable pod-making machine for brewing products, comprising:
a feeding unit of at least one sheet made of biodegradable material with gas barrier properties,
a conformation device provided with
a shaping device comprising at least one mobile punch approaching and moving away from a die provided with a concavity delimited around the edge by a peripheral edge, said shaping device being configured to shape at least one concave portion and a corresponding peripheral annular portion on said sheet, and
a folding element configured to be placed outside the peripheral edge of the die to make a fold in the sheet at said peripheral annular portion so as to define at least one stiffening annular portion of the sheet.

7. The shaping station according to claim 6, wherein said folding element is mobile approaching and moving away from an abutment portion that is placed outside the peripheral edge of the die and that is configured to receive said folding element against it in order to make said fold.

8. The shaping station according to claim 7, wherein said abutment portion, with reference to a reciprocal movement direction between the punch and the die, is interposed between said peripheral edge of the die and a bottom portion of the concavity.

9. The shaping station according to claim 8, wherein the distance, measured along the reciprocal movement direction between the punch and the die, between the peripheral edge and the abutment portion ranges between 0.5 mm and 2 mm, and is preferably equal to 1.3 mm; and wherein the distance, measured along the reciprocal movement direction between the punch and the die, between the peripheral edge and the bottom portion ranges between 3 mm and 7 mm, and is preferably equal to 5 mm.

10. The shaping station according to claim 6, comprising a moistening device of at least one portion of said sheet and wherein said conformation device comprises heating means configured to dry said at least one concave portion allowing the maintenance of said concave conformation.

11. The shaping station according to claim 10, wherein said heating means comprising a heating device joined to said punch and/or to said die in order to dry the portion of the sheet during its conformation.

12. A compostable pod making machine for brewing products, comprising:
a first shaping station configured to make available a first sheet made of biodegradable material with gas barrier properties provided with at least one first concave portion;
a second shaping station configured to make available a second sheet made of biodegradable material with gas barrier properties provided with at least one second concave portion;
a filling station operationally arranged downstream of said first shaping station and configured to fill said first concave portion with a predetermined quantity of a brewing product; and
a coupling station operationally arranged downstream of said filling station and configured to couple the sheets at the peripheral annular portions so that the respective concavities of the concave portions are opposite each other and define a housing volume of said brewing product.
